(19) United States
(12) Patent Application Publication
(10) Pub. No.: US 2011/0236846 A1
(43) Pub. Date: Sep. 29, 2011

(54) Submerged combustion melter

(75) Inventors: David M. Rue, Chicago, IL (US); Grigory I. Aronchik, Elmwood Park, IL (US); Mark J. Khinkis, Morton Grove, IL (US); Walter Kunc, Clarendon Hills, IL (US)

(73) Assignee: GAS TECHNOLOGY INSTITUTE, Des Plaines, IL (US)

(21) Appl. No.: 12/009,471

(22) Filed: Jan. 18, 2008

(51) Int. Cl. F27B 3/22

(52) U.S. Cl. 432/195

(57) ABSTRACT

A submerged combustion melter having a plurality of side walls, a bottom wall adjacent the side walls, and a top wall adjacent the side walls, the walls collectively enclosing a melting chamber, and the bottom wall forming a plurality of openings, each of which is adapted to receive a submerged combustion burner. Each of the submerged combustion burners is positioned at least 4 inches from the side walls, at least twice as far apart from each other as the distance between the submerged combustion burners and the side walls, and less than or equal to about 20 inches apart.

The U.S. Government has a paid-up license in this invention and the right in limited circumstances to require the patent owner to license others on reasonable terms as provided for by the terms of Contract No. DE-FC36-03GO13092 awarded by the U.S. Department of Energy.

### BACKGROUND OF THE INVENTION

This invention relates to a process and apparatus for submerged combustion melting.

Submerged combustion melting is an advanced melting technology for economically and cleanly producing homogeneous mineral melts. Numerous industrially and environmentally useful melts can be produced by submerged combustion melting at operating and capital cost advantages compared to other melting techniques. Submerged combustion melting provides a combination of features not available in any other melting technology.

In submerged combustion melting, burners fire natural gas or other fuel gas and oxidant, i.e. air, oxygen-enriched air, or oxygen, from directly under and into a bath of material undergoing melting. The intimate contact of combustion gases and melt generates a bubbling bath along with extremely high rates of mass and heat transfer. A homogeneous product is formed from any combination of mixed or separate feed streams with particles covering a wide size range. The melter walls may be externally cooled by water to produce hot water or steam or they may be cooled by other heat transfer fluids.

An apparatus suitable for performing submerged combustion melting requires very little refractory which, in combination with small melt pools typically employed, enables rapid startup and shutdown. Combustion in the melt reduces flame temperature, which results in extremely low NOₓ emissions compared with other combustion processes, and complete combustion within the melt results in low CO and unburned hydrocarbon emissions. Fine feed material can be charged below the melt line to minimize the amount of fines and droplets in the exhaust gas. Melter size and cost are low because of the intense heat and mass transfer and the use of externally cooled walls instead of large quantities of refractory.

Thus, submerged combustion melting provides the following simultaneous advantages compared with conventional gas-fired, electric, and plasma industrial technologies for producing high-temperature mineral melts: a) compact size leading to high production rate (or pull rate) in mass per unit surface area per unit time; b) high heat and mass transfer rates; c) low cost; d) the ability to be started and stopped quickly; e) low use of refractory; f) ability to produce a homogeneous melt from multiple non-homogeneous streams of feed solids or slurries; g) the ability to charge feed materials below the melt line; and h) low emissions (CO, NOₓ, unburned hydrocarbons, and particulates).

While submerged combustion melting is known, practical applications have been limited due to a lack of practical ways to address several issues relating to the technology. These issues include: a) poorly designed burner firing patterns which can lead to the bypass of feed particles before they are fully melted; b) poorly placed burners which can produce undesirable hot spots in the melt and on the melt chamber walls; and c) low efficiency and low production rates relative to optimum submerged combustion melter potential which can result from improper melt chamber shape and improper placement of the discharge port. Addressing these problems of conventional submerged combustion melters is essential for the technology to gain widespread industrial acceptance and use. Without solving the first problem, product melt will never meet industrial quality specifications. Without solving the second problem, volatile components of the melt will be lost and melter life will be short. Without solving the third problem, efficiency will be low and melter cost will be high, making industrial choice of this technology unlikely.

### SUMMARY OF THE INVENTION

Accordingly, it is one object of this invention to provide an apparatus for submerged combustion melting which reduces the bypass of feed particles before they are fully melted compared with known submerged combustion melters.

It is another object of this invention to provide an apparatus for submerged combustion melting which reduces undesirable hot spots in the melt and on the melt chamber walls compared with known submerged combustion melters.

It is yet another object of this invention to provide an apparatus for submerged combustion melting having greater efficiencies and higher production rates than comparably sized known submerged combustion melters.

These and other objects of this invention are addressed by a submerged combustion melter having a plurality of side walls, a bottom wall adjacent to the side walls, and a top wall adjacent to the side walls, which walls collectively enclose a melting chamber. The bottom wall forms a plurality of openings, each of which is adapted to receive a submerged combustion burner. Each of the submerged combustion burners is positioned at least 4 inches from the side walls, at least twice as far apart from each other as the distance between the submerged combustion burners and the side walls, and less than or equal to about 20 inches apart. By virtue of this arrangement, as will be discussed in more detail herein below, the bypassing of feed particles before they melt is substantially eliminated, hot spots in the melt and on the melt chamber walls are substantially reduced, and this increases melter efficiency.

### BRIEF DESCRIPTION OF THE DRAWINGS

These and other objects and features of this invention will be better understood from the following detailed description taken in conjunction with the drawings wherein:

FIG. 1 is a schematic lateral cross-sectional view of a submerged combustion melter in accordance with one embodiment of this invention;

FIG. 2 is a diagram showing path lines for incoming flow in a cylindrical submerged combustion melter obtained by computational fluid dynamics (CFD) modeling;

FIG. 3 is a schematic diagram of an extended octagonal shaped submerged combustion melter in accordance with one embodiment of this invention;

FIG. 4 is a diagram showing the path lines for incoming flow into the octagonal submerged combustion melter of FIG. 3;

FIG. 5 is a schematic diagram showing the optimal temperature distribution in a submerged combustion melter in accordance with one embodiment of this invention; and

FIG. 6 is a diagram showing the effect of a feed pocket for a submerged combustion melter in accordance with one embodiment of this invention.

### DETAILED DESCRIPTION OF THE PRESENTLY PREFERRED EMBODIMENTS

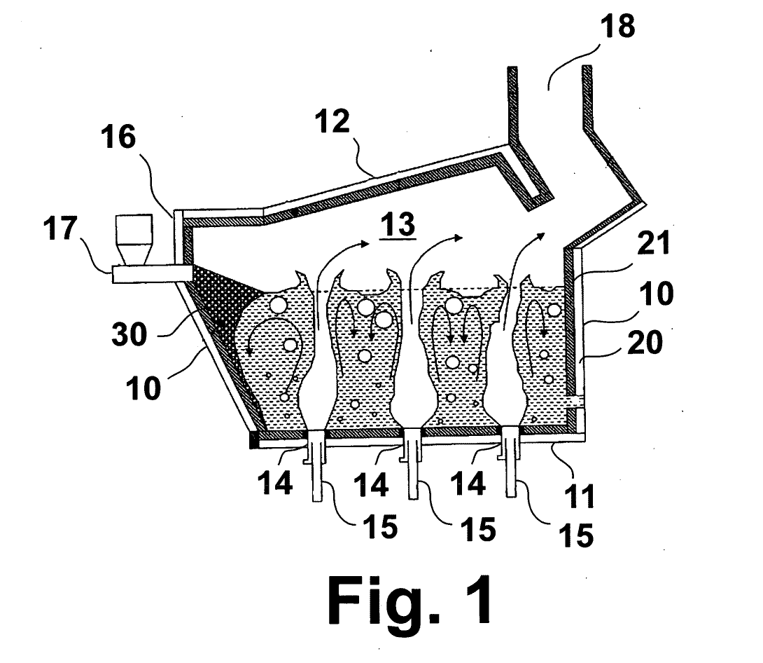

FIG. 1 is a lateral cross-sectional view of a submerged combustion melting apparatus in accordance with one embodiment of this invention. The apparatus comprises a plurality of side walls 10, a bottom wall 11 adjacent the side walls, and a top wall 12 adjacent the side walls, which walls collectively enclose a melting chamber 13. The bottom wall 11 forms a plurality of openings 14, each of which is adapted to receive a submerged combustion burner 15. As melter size is increased, the number of burner rows amend number of burners in each row is increased. Connected with one side wall, referred to herein as a feeder side wall 16, is a feeder 17 through which raw materials to be melted are introduced into the melting chamber 13. The apparatus further comprises a flue gas exhaust opening 18 through which combustion product gases are expelled from the melting chamber.

In accordance with one embodiment of this invention, the walls of the submerged combustion apparatus are constructed of intensively cooled panels 20 adapted to withstand intensive thermal and chemical erosion. Water, steam, or other appropriate liquids may serve as heat carriers to cool the panels. The system of panels enables the building of melters having various configurations in accordance with a variety of specific melting performance requirements.

In submerged combustion melting, fuel (preferably natural gas, or possibly other gaseous, liquid, or solid hydrocarbon fuels) and oxidant (air, oxygen-enriched air, or oxygen) are fired directly into the bath of material being melted. Burners in a submerged combustion melter provide heat input for melting as well as kinetic energy to form the requisite flow patterns for ensuring sufficient residence time and homogenization. One surprising result is that very stable combustion can be maintained over a wide (10:1) turndown ratio. This may be achieved with a special submerged combustion burner, which stabilizes the base of the flame just below (or outside) the melt bath through partial or full premixing. Such a burner is taught, for example, by U.S. Pat. No. 7,273,583 which is incorporated in its entirety by reference herein. Combustion under the melt surface creates a complex, multi-phase fluid system characterized by highly intensive mixing of the components and large heat and mass transfer surface areas. These conditions provide a combination of effects including a significantly increased rate of heat exchange between the combustion products and the material being melted, increased rates of melting and chemical reaction, greater product melt homogeneity, and decreased emissions of CO, unburned hydrocarbons, and NOₓ.

A homogeneous melt product may be generated when the feed materials to the melter are charged in either continuous or batch modes; when the feed materials are fine solids to pieces up to 6 inches in diameter; when the feed materials are solids, liquids, or gels; when the feed materials contain high concentrations of water and/or organic material; when a single feed material stream or multiple streams are used; and when the feed materials are charged from above the melt line or from below the melt surface. Feed can also be charged in such a way that, if desired, some material enters the melt chamber continuously and other material is introduced in batches.

The submerged combustion melter may be operated under reducing conditions (fuel-rich combustion), stoichiometric conditions, or oxidizing conditions (fuel-lean combustion) in the melt chamber. Melt bath temperatures of 1000° F. to 3300° F. may be maintained during steady operation. Feed to the melter may contain a high concentration of water up to 60 percent and/or high concentrations of organic material up to 50 percent. Rapid mixing in the melt chamber spreads the feed moisture vaporization across the melt chamber cross-section and thereby prevents explosive steam formation. The great majority of water in the feed materials is vaporized by contact with hot exhaust gases leaving the melt and is carried out with the exhaust gas, all occurring before the feed reaches the melt surface. Intimate contact between the melt and the combustion process enables complete combustion of all organic materials in the feed materials. Organic feed material actually adds to the thermal energy input to the process and decreases the process fuel requirements to the submerged combustion burners. Under this mode of operation, fue-to-oxidant ratios to the burners must be adjusted to maintain desired overall stoichiometry.

A submerged combustion melter in accordance with this invention comprises the following basic characteristics. The melter shape, the feeder location, and the location of the burners on the melter floor provide a substantially uniform residence time distribution for all incoming raw material particles. Absent such characteristics, unmelted inclusions in outgoing product melt will reduce the product melt quality to inappropriate levels.

One of the most important requirements for ensuring substantially uniform residence time distribution is symmetry, that is, a symmetrical melter shape and placement of feeders, burners, and product melt discharge port in symmetric positions relative to the shape of the melter.

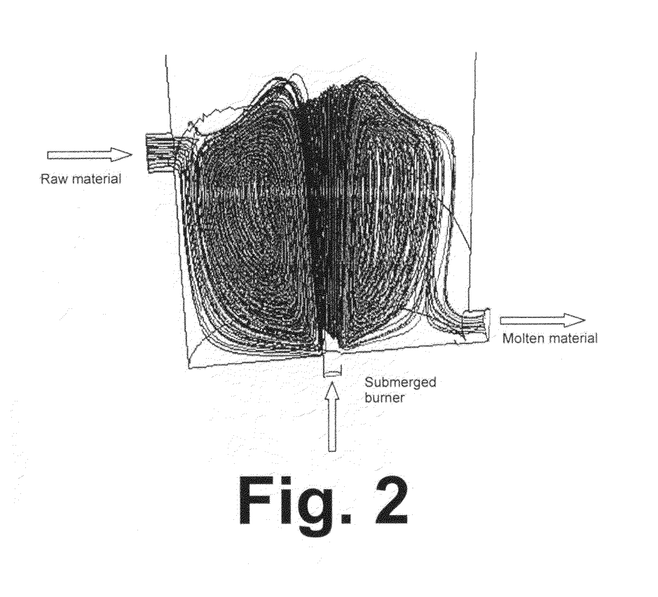

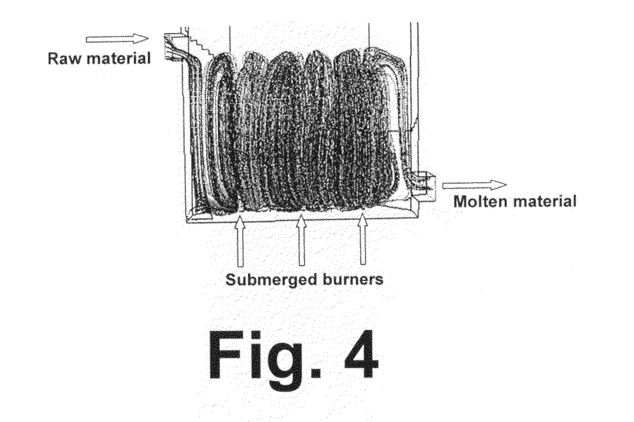

A second requirement is the substantial elimination or prevention of shortcut bypasses within the melt flow patterns, that is, areas within the melt flow patterns through which unmelted particles of material may pass. In the operation of a submerged combustion melter, each submerged combustion burner creates a spiral circulation around the burner. For example, in a cylindrical submerged combustion melter having a single submerged combustion burner, the spiral circulation may be as shown in FIG. 2. FIG. 4 shows the spiral circulation patterns which may be generated by a plurality of submerged combustion burners in a polygonal shaped submerged combustion melter. It will be apparent that the flow pattern generated by one submerged combustion burner may influence the flow pattern generated by a nearby submerged combustion burner depending among other things upon the distances between the burners. Intuition would suggest that the elimination of shortcut bypasses is best achieved by maintaining a distance between the burners such that overlap exists between the spiral flow patterns generated by neighboring burners. Counter-intuitively, we have found that the distance between burners should be sufficient to ensure that all flow patterns around the burners have enough space to fully develop and to ensure that interactions between adjacent spiral patterns is minimized so that unmelted particles circle around the burners in the spiral, convective flow patterns. Unacceptably short residence times from bypassing the flow patterns are prevented by selecting proper burner locations.

A third requirement for ensuring substantially uniform residence time distribution is uniformity of the temperature field within the submerged combustion melter. Uniformity of the temperature field provides the best conditions for melting/homogenization in the whole melter including in the relatively cold regions in the corners and along the cooled walls. The thermal efficiency, which requires heat input distribution optimization within the bath and heat loss minimization, also should be high enough. It will be appreciated that melter shape and burner locations affect not only the residence time distribution, but also the thermal efficiency.

To obtain substantially uniform residence time of materials within the submerged combustion melter, we have discovered that, in addition to having a symmetrical disposition, the submerged combustion burners must be positioned in accordance with the following parameters. In particular, each of the submerged combustion burners must be positioned at least 4 inches from the melter side walls, at least twice as far apart from each other as the distance between the submerged combustion burners and the side walls, and less than or equal to about 20 inches apart. In accordance with one preferred embodiment, the submerged combustion burners closest to the side walls are positioned less than or equal to about 10 inches from the side walls.

The optimal distance between the burners and the closest cooled walls should be such as to minimize the volume of melt in the relatively colder corners between cooled walls and cooled floor and to minimize the volume of relatively cold liquid in the vicinity of the walls. However, if the distance between burners and walls is too small, unacceptable increases in heat loss will be realized through the walls. The optimal distance for glass melters is about 15 cm (6 inches) but may be between 4 and 10 inches with certain glasses. Both rectangular and cylindrical cross section shapes are acceptable for melters with low requirements for melt homogeneity, and for melters working periodically.

A cylindrical melter with a single, central burner provides the ideal flow pattern of the melt and practically equal residence time values for all incoming particles. FIG. 2 shows path lines for incoming flow in a cylindrical submerged combustion melter obtained by CFD modeling.

For continuously working melters with big production rates that cannot be handled by a single burner, i.e. in excess of approximately 1 ton/h of melt, the cylindrical shape is unacceptable because the multiple submerged burners needed cannot be placed in such a way that leads to required uniformity of residence time values for all raw material particles. Multiple burners in a circular cross-section submerged combustion melter may also lead to inactive zones within the bath where circulation is very weak. Although undesirable, circular submerged combustion melters with multiple burners placed in a symmetric pattern can be operated and may be selected under certain conditions. If multiple burners are selected, the burners should be placed as follows: 2 burners—in a line between the feed and melt discharge 180 degrees apart with distances between feed, burner 1, burners 1 and 2, and burner 2 and discharge as equal as practicable; 3 or more burners—in a circle with all burners the same distance apart and the same distance from the outside wall. This pattern is preferred for large melters over 2 tons per hour.

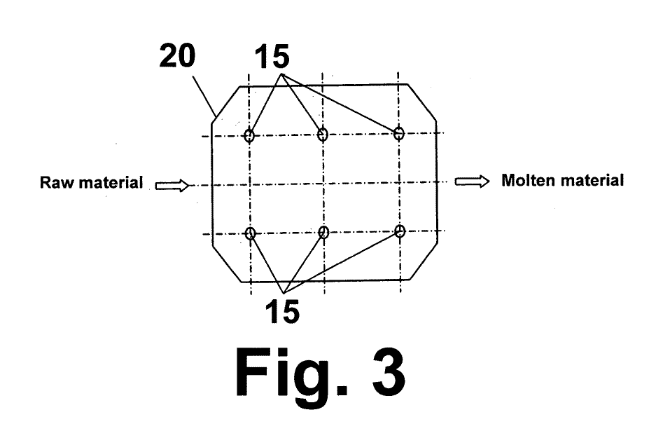

A rectangular melt bath shape is more convenient for the melt bath due to its flexibility to the number of burners that may be installed and better residence time control. However, rectangular shape melters have at least one important disadvantage. The right angle corners between two cooled walls may contain unmelted raw material, serving as sources of unpredictable and uncontrolled intrusions of unmelted particles and components, thereby reducing the quality of the melt. This problem may be addressed by an “extended” octagonal shape melter as shown in FIG. 3. The melter in FIG. 3 is characterized by symmetry and well developed flow patterns around each burner as suggested by the path lines for incoming flow obtained by CFD modeling in an isothermal bath shown in FIG. 4. All corners are in excess of 90 degrees, which decreases wall corner interruptions of flow patterns and decreases excessive corner cooling of the melt.

As previously indicated, bypasses between spiral flow patterns around neighboring burners are minimized by appropriate choice of spacing between the burners. For submerged combustion glass melters, the preferred distance between any two adjacent burners is about 40 cm (16 inches). Smaller spacing may result in interference between submerged flames/jets, poor circulation, and the existence of short cuts, all yielding poorer (broader) residence time distribution. Larger distances may unreasonably increase wall area and total heat loss through the walls.

Entrainment of relatively volatile components of raw material and melt droplets in exhaust gas should be minimized to ensure the required melt chemical composition and acceptable operating costs. Feed should be charged to the melter in a manner such that volatile component volatilization is minimized. This may be achieved by introducing the feed at a location in the submerged combustion melter at which the established melt flow patterns draw the feed down into the melt as quickly as possible. Once covered with melt, volatile components are much less likely to be volatilized from the melt.

The objective in commercial practice is to optimize product quality while minimizing capital cost and fuel consumption. This is accomplished by establishing the most uniform possible temperature distribution because higher temperatures lead to wasted fuel. This is also accomplished by providing thorough mixing without creating random mixing because random mixing leads to some feed material exiting the melter before having sufficient time at temperature to fully melt and mix with the bulk molten material. Maximum melter pull rate is achieved by selection of specific burner patterns. The preferred burner patterns for a submerged combustion melter in accordance with this invention are described below.

In accordance with one embodiment of this invention, the burners are positioned in a range of about 4 inches to about 10 inches from melt chamber side walls, and preferably a range of about 5 inches to about 7 inches, from the melt chamber side walls. This distance range provides a substantially optimal temperature distribution in the melter, substantially prevents buildup of highly viscous material on the walls, and substantially prevents material bypass between the side walls and the burners. In accordance with one embodiment of this invention, the distance between the burners is in the range of about 12 inches to about 20 inches, more preferably in the range of about 15 inches to about 18 inches, which distance is at least double the distance between the burners and the side walls. Placement of the burners at least twice as far apart as the distance between the burners and the side walls effectively prevents interaction between the flow loops of two neighboring burners. Such interaction, were it to be permitted, would cause random mixing and bypassing of unmelted material past one or more of the burners.

Submerged combustion melters may have a wide range of sizes. Small units (less than about 1 ton/hour) may have a single burner, but as the melter capacity increases, multiple burners are required to prevent firing all the way through the melt, which wastes fuel. Multiple burners are needed to form uniform temperature profiles and controlled residence time distributions in the melt bath and cannot be randomly placed. For large melters in accordance with one embodiment of this invention having four or more burners, the burners are preferably disposed at the vertices of a rectangular (or square) grid pattern on the melter floor. This pattern is superior to all other possible patterns because it substantially prevents passage of melt from one row of burners ‘around’ the next row of burners. Melt may pass ‘around’ a row of burners by passing in the less turbulent area between two burners or along the walls away from the burners, which, in turn, may prevent melt from entering the burner convective flow loops in the next row as desired. For smaller capacity submerged combustion melters, 2 or 3 burners are positioned in a straight line preferably along the melter centerline in the direction of overall melt flow from the feeder to the product discharge. For the smallest melters using a single burner, the burner is placed in the center of the melter floor.

The minimal depth of the melt bath is limited by conditions of well-developed melt circulation without intensive flashing. The maximum depth of the bath is limited by the maximum acceptable static pressure of the melt at a given fuel/oxidant pressure. Melt depth of the molten material in the submerged combustion melter in accordance with one embodiment of this invention is in the range of about 1 foot to about 7 feet and, in accordance with one preferred embodiment of this invention in the range of about 2 feet to about 6 feet. If melt depth is below the minimum level, the burners will fire through the melt and heat will be wasted by not being transferred into the melt bath. In addition, convective flow loops will not form in the melt around the burners; thus temperature uniformity and a controlled residence time pattern will not be established. If the melt level is higher than the maximum desired level, convective flow loops will collapse from excessive hydrostatic head and, thus, fail to distribute heat throughout the melt bath. Also, the pressure needed for the fuel gas and oxygen supplies to the burners will be excessive and add operational costs.

Establishment of convective flow loops around each burner requires melt viscosity to be within a certain range. When the melt viscosity is too low, the convective flow loops will not form and random mixing and excessive splashing will occur. When the melt viscosity is too high, the melt will not flow in convective loops and the gaseous combustion products will ‘channel’ directly to the melt surface. When convective flow loops do not form, poor mixing occurs and temperatures are not uniform in the melt bath since convective flow loops distribute heat away from the burners and into the bulk molten bath. In accordance with one embodiment of this invention, the melt bath average viscosity is in the range of about 100 poise to about 50,000 poise, and preferably in the range of about 500 poise to about 10,000 poise.

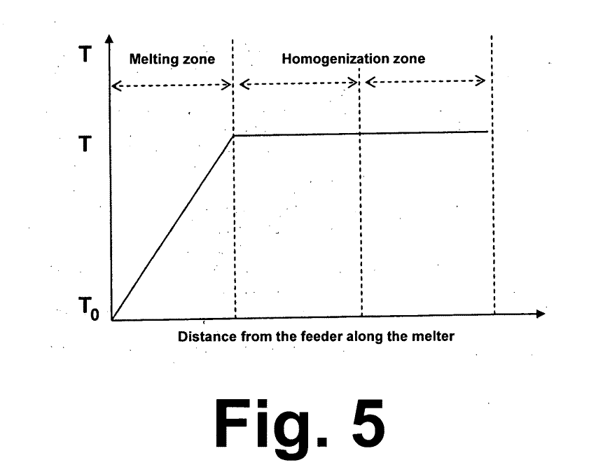

Heat input into the melt from the first row of burners nearest the feed side wall provides heat for melting. The first zone, i.e. melting zone, of the bath as defined by the first row of burners serves primarily as a melting zone and requires more heat input than the downstream zones, which primarily provide homogenization and extended residence time. If the firing rate of the burners located within the melting zone is maximized to obtain the maximum thermal efficiency, the overall heat input in the zones of homogenization will be just enough to compensate for the heat loss, to maintain minimal necessary temperature of the melt, and to maintain the vertical convective flow loops around the burners. The typical optimum temperature distribution along the melter is shown schematically in FIG. 5. It will be appreciated by those skilled in the art that, although burners close to the feed end of the melter may be fired at a higher capacity than burners closer to the discharge end of the melter, such variation of firing rates does not change the parameters for burner placement and melt bath operation as set forth herein. The volume of melt influenced by the convective flow loops of burners operated at varying firing capacities is not sufficiently different to warrant repositioning of the burners.

In order to obtain a temperature field similar to that shown in FIG. 5, the heat input distribution along the rows of burners should be non-uniform. For example, if the overall heat input is considered as 100%, the preferred heat input values for the first, second, and third rows of the burners in submerged combustion glass melters with three rows of the burners are approximately 40-50%, 25-30%, and 25-30% respectively. Burner sizes may be varied for each row to accomplish the desired heating pattern.

For the case of octagonal shape melters as shown in FIG. 3, reduced heat input into the downstream zones versus that in the first zone leads to decreased firing rates, which may be unacceptable due to unstable combustion at reduced firing rates and/or lack of the jet's kinetic energy for appropriate mixing. This consideration limits the range of firing rate distributions for the three burners row example between the rows of burners from all three rows being equal to the values shown above.

In a submerged combustion melter, the melt is very mobile because of the three-phase nature of the melting process with gaseous products of combustion bubbling through the liquid melt and the solids not yet melted. Under these conditions, refractory covered walls used in conventional high temperature melt tanks exhibit excessive wear (dissolution or recession). This problem may be addressed in accordance with one embodiment of this invention by constructing the melt bath walls using cooled panels 20 covered with a relatively thin layer 21 of refractory (0.5 to 4 inches) on the melt facing surfaces of the panels, as shown in FIG. 1.

The melter walls are a dynamic part of the submerged combustion melting process. The cooled melter wall panels with refractory in accordance with one embodiment of this invention serve the dual role of minimizing heat loss while forming a frozen glass layer (or a layer so viscous that the layer moves very little). This frozen (or highly viscous layer) protects the melter walls and also decreases convective heat losses to the walls.

During operation of a submerged combustion melter, cooling may provide a layer of frozen melt (at least 0.2 in. thick) on the refractory surface, thereby protecting the refractory. Depending on the type of refractory installed, the protected refractory may survive indefinitely during operation and may even be replaced entirely by the protective layer of frozen melt, that is, without any refractory at all. To ensure proper formation of the frozen layer, the melt must initially wet the surface of the refractory. Advantages of the formation of the frozen layer include the use of less refractory compared with conventional non-cooled furnaces, the use of less expensive and exotic refractories since the refractory is not exposed to the molten material in the bath (even chemically incompatible and low-temperature refractories may be used with melts that will attack all standard refractories because the melt only comes into contact with the frozen layer of melt on the refractory surface), and relatively constant energy loss from the furnace through the cooled walls at different firing rates and melt temperatures, which simplifies furnace operation. In accordance with one embodiment of this invention, the refractory thickness of the portion of the melter walls below the melt line of the melter, the melt line substantially corresponding to the level of the top surface of the melt, is less than the refractory thickness of the portion of the melter walls above the melt line. The heat flux through the frozen melt lining is determined by the physical and chemical properties of the melted material and the temperature of the melt. The values of the heat flux are relatively independent of the temperature of the coolant as any increase or decrease in the coolant temperature is accompanied by a compensating change in the thickness of the lining.

The submerged combustion melter in accordance with this invention may employ multiple types of feeders. In accordance with one embodiment of this invention, the feeder is disposed on the melt chamber wall above the melt such that the raw feed materials fall onto the surface of the melt. In accordance with another embodiment of this invention, the feeder is disposed through the melter roof such that the raw feed materials fall directly onto the melt surface. In accordance with yet another embodiment of this invention, the feeder is disposed through the melt chamber wall below the melt line such that the raw feed material is continually pushed directly into the melt.

Although a vertical feeder side wall may be employed, such an arrangement produces limitations in feed rate and may lead to higher particle entrainment or component volatilization. Intensive bubbling and unstable gas channels created by submerged combustion burners may lead to feed particle entrainment or raw material volatile component volatilization and carryover into the exhaust gas. This effect is most pronounced when the feed side wall is vertically oriented.

In accordance with one embodiment of this invention as shown in FIG. 1, the side wall 10 to which the feeder 17 is attached is sloped at an angle in a range of about 5° to about 45° from vertical, thereby forming a feed pocket 30 in the melting chamber. In accordance with one embodiment of this invention, the slope continues all the way to the bottom wall 11. In accordance with another embodiment of this invention, the sloped side wall connects with a vertical melter side wall at a location below the melt line. By using a sloped side wall, particle carryover and component volatilization concerns are decreased due to the sloped feed pocket 30, which creates a quiet zone free from direct impact of submerged flames/jets and minimizes the entrainment and volatilization. Since the sloped feed pocket keeps relatively cold raw material flow from the first zone of the melter and directs the raw material to the roots of the submerged flames/jets, circulation within the bath is improved and residence times are increased. In the absence of a sloped feed pocket, cold raw material intrusion into the upper part of the melting zone depresses and destroys melt circulation in the area of the first burners due to low temperature and high melt viscosity.

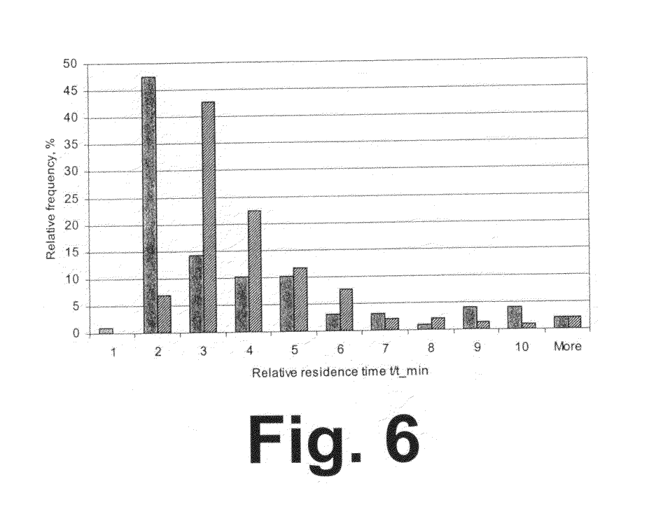

The influence of the sloped feed pocket on residence time values is illustrated by FIG. 6, which shows that in a melter having a sloped feed pocket in accordance with one embodiment of this invention, the majority of incoming particles of raw material have about a 1.5 times greater residence time value than those in a melter without the feed pocket. The results presented in FIG. 6 have been obtained by CFD modeling of heat transfer and hydrodynamics of two glass melters at similar conditions.

While in the foregoing specification this invention has been described in relation to certain preferred embodiments thereof, and many details have been set forth for purpose of illustration, it will be apparent to those skilled in the art that the invention is susceptible to additional embodiments and that certain of the details described herein can be varied considerably without departing from the basic principles of the invention.

We claim:

1. In a submerged combustion melter having a plurality of side walls, a bottom wall adjacent said side walls, and a top wall adjacent said side walls, said walls collectively enclosing a melting chamber, and said bottom wall forming a plurality of openings, each said opening adapted to receive a submerged combustion burner, the improvement comprising:
each of said submerged combustion burners positioned at least 4 inches from said side walls, at least twice as far apart from each other as the distance between said submerged combustion burners and said side walls, and less than or equal to about 20 inches apart.

2. The submerged combustion melter of claim 1, wherein said submerged combustion burners closest to said side walls are positioned less than or equal to about 10 inches from said side walls.

3. The submerged combustion melter of claim 1, wherein a molten material is disposed within said melting chamber, said molten material having a viscosity in a range of about 100 to about 50,000 poise.

4. The submerged combustion melter of claim 1 further comprising cooling means for cooling said side walls disposed adjacent said side walls.

5. The submerged combustion melter of claim 3, wherein said molten material has a depth in a range of about 1 foot to about 7 feet.

6. The submerged combustion melter of claim 1, wherein one of said side walls is a feeder side wall comprising feeder means for feeding raw materials into said melting chamber.

7. The submerged combustion melter of claim 6, wherein said feeder side wall is inclined outwardly from said melting chamber at an angle in a range of about 5° to about 45° from vertical.

8. The submerged combustion melter of claim 1, wherein said side walls are constructed of fluid-cooled panels.

9. The submerged combustion melter of claim 8, wherein a melt-facing side of said fluid-cooled panels is covered with a layer of refractory material having a thickness in a range of about 0.5 inches to about 4.0 inches.

10. The submerged combustion melter of claim 1, wherein said walls comprise a refractory layer and said refractory layer of said bottom wall and a portion of said side walls below a melt line of said melting chamber is thinner than said refractory layer above said melt line.
